(19) United States
(12) Patent Application Publication
(10) Pub. No.: US 2009/0271225 A1
(43) Pub. Date: Oct. 29, 2009

(54) Systems, Methods, and Media for Managing Transfers of Existing Reservations

(75) Inventors: William C. Schreiber, Wilson, WY (US); Catherine R. Wyer, Jackson, WY (US)

Correspondence Address: SCHUBERT OSTERRIEDER & NICKELSON PLLC, 6013 CANNON MTN DR, S14, AUSTIN, TX, 78749, US

(73) Assignee: Vacation Cancellation Inc., Jackson, WY (US)

(21) Appl. No.: 12/111,467

(22) Filed: Apr. 29, 2008

(51) Int. Cl. G06Q 10/00

(52) U.S. Cl. 705/5

(57) ABSTRACT

Generally speaking, systems, methods and media for managing transfers of existing reservations are disclosed. Embodiments may include enrolling business members with the reservation manager and receiving and storing indications of reservations to list for sale. Embodiments may also include receiving from a buying user a request to search reservation listings of reservations listed for sale and generating and transmitting search results, the search results including reservation listings offered for sale that satisfy the received request from the buying user and a price associated with each reservation listing. Embodiments may also include receiving a request from the buying user to purchase a particular reservation from its associated selling user. Embodiments may also include transmitting an indication of the purchase of the particular reservation to a business member associated with the particular reservation to facilitate transfer of the particular reservation by the business member from the selling user to the buying user.

### FIELD OF INVENTION

The present invention is in the field of data processing systems and, in particular, to systems, methods and media for managing transfers of existing reservations, such as by facilitating transfer of an existing reservation from one reservation holder to another.

### BACKGROUND

The travel and entertainment industries continue to grow in size and importance as more individuals travel for both work and pleasure. Often, as part of travel, individuals make use of service providers such as hotels or other lodging providers, transportation companies, entertainment providers (e.g., river rafling guides, playhouses, opera houses, package tour companies, etc.), or other companies during their travel. It is common for individuals to make reservations with these service providers to preserve their right to use the service at the scheduled time or day. A reservation may typically consist of a set of conditions (such as price, time, location, or type of service) which a provider agrees to provide consistent with the set of conditions. An individual may, for example, reserve a vacation package for a three-day weekend at a particular bed and breakfast in Vermont for a price of $600 per person. By making a reservation, the individual can guarantee that the service will be available to them when they need it and at the reserved price. In exchange, however, providers often require a security deposit in advance from the individual making the reservation. In many cases, the security deposit is retained by the provider in the event that the individual cannot or does not utilize the service so that the provider is compensated when the individual does not utilize the service and thus does not pay for the service beyond their security deposit. Terms and conditions of the reservation typically specify a cancellation policy that provides for refund of the deposit only if particular conditions are met, such as by requiring cancellation sufficiently far in advance of the reservation date or time.

If an individual cannot use their reservation and does not qualify for return of their deposit per the cancellation policy, the service provider will retain the security deposit and the individual will lose the entire deposit. Loss of a security deposit is an obvious detriment to the individual, but it may also be a detrimental situation for the service provider. While the service provider does retain those funds, they may not be able to find a replacement to fill that “slot” and thus will not receive the difference between the security deposit and the full price of the reserved service. Moreover, if nobody uses that reservation, many service providers will also lose ancillary revenue they may receive from on-site restaurants, gift shops, etc.

One solution to this problem would be for individuals to convince someone else to take over their reservation. This solution, however, is hampered by the fact that individuals will typically not have a broad base of people they know who can take over the reservation. This may be exacerbated by the fact that the issues causing the missed reservation (e.g., death in the family, sickness, etc.) may make the individual who cannot use the reservation unable or unwilling to put significant effort into finding someone to take over their reservation. Even if someone to take the reservation is found, most service providers do not necessarily want to get involved in dealing with such a situation as it causes them significant complication and the potential for confusion. Another solution is for the service provider themselves to seek a replacement to take over the reservation. In the event that the service provider does find a replacement to take over the reservation, they incur the cost and inconvenience of having to find such a replacement. While the service provider does benefit from retaining the security deposit from the original reservation holder, they may, however, also suffer some resentment (and thus decreased potential of future patronage) from the individual who lost their security deposit. Transfers of existing reservations from one customer to another in the event of a cancellation may thus result in significant customer service issues for service providers. A solution that provides for effective and efficient transfer of reservations may accordingly be desirable for many service providers or other entities honoring reservations.

### SUMMARY OF THE INVENTION

The problems identified above are in large part addressed by systems, methods and media for managing transfers of existing reservations. A method for managing transfers of existing reservations by a reservation manager is disclosed. A reservation may typically consist of a set of conditions (such as price, time, location, or type of service) which a provider agrees to provide consistent with the set of conditions. Embodiments of the method may include enrolling one or more business members with the reservation manager and receiving and storing indications of one or more reservations to list for sale, where each of the reservations for sale is associated with an enrolled business member and a selling user holding the reservation. Embodiments may also include receiving from a buying user a request to search reservation listings of reservations listed for sale and generating and transmitting search results based on the received request, where the search results include one or more reservation listings offered for sale that satisfy the received request from the buying user and a price associated with each reservation listing. Embodiments may also include receiving a request from the buying user to purchase a particular reservation from its associated selling user holding the particular reservation. Embodiments may also include transmitting an indication of the purchase of the particular reservation to a business member associated with the particular reservation to facilitate transfer of the particular reservation by the business member from the selling user to the buying user.

Another embodiment provides a computer program product comprising a computer-useable medium having a computer readable program wherein the computer readable program, when executed on a computer, causes the computer to perform a series of operations for managing transfers of existing reservations. The series of operations generally includes enrolling one or more business members with the reservation manager and receiving and storing indications of one or more reservations to list for sale, where each of the reservations for sale is associated with an enrolled business member and a selling user holding the reservation. Embodiments may also include a series of operations for receiving from a buying user a request to search reservation listings of reservations listed for sale and generating and transmitting search results based on the received request, where the search results include one or more reservation listings offered for sale that satisfy the received request from the buying user and a price associated with each reservation listing. Embodiments may also include a series of operations for receiving a request from the buying user to purchase a particular reservation from its associated selling user holding the particular reservation. Embodiments may also include a series of operations for transmitting an indication of the purchase of the particular reservation to a business member associated with the particular reservation to facilitate transfer of the particular reservation by the business member from the selling user to the buying user.

A further embodiment provides a data processing system having a machine-accessible medium storing a plurality of program modules. Embodiments may include a business member interface module to facilitate communications to and from business members who enroll with a reservation manager. Embodiments may also include a customer interface module to facilitate communication to and from users desiring to sell or purchase reservations held with enrolled business members. Embodiments may also include a customer manager to manage sale and purchase of reservations by users. The customer manager may include a customer listing module to facilitate listings of reservations for sale by selling users, a reservation search module to facilitate searches of reservations for sale by buying users, and a customer payment module to process purchases of reservations at a specified price by buying users. Embodiments may also include a business member manager to manage business members. The business member manager may include a membership module to enroll business members with the reservation manager and a reservation transfer module to transmit an indication of the purchase of a particular reservation to a business member associated with the particular reservation to facilitate transfer of the reservation by the business member from a selling user to a buying user.

Another embodiment provides a method for transferring reservations. The method may include enrolling by a business member with a reservation manager and receiving notification of a purchase by a buying user at a specified price for a particular reservation, the particular reservation being associated with a selling user holding the particular reservation and the enrolled business member. Embodiments may also include receiving an indication of payment from the reservation manager for the purchased particular reservation and verifying the particular reservation held by the selling user. Embodiments may also include in response to verifying the particular reservation, transferring the particular reservation from the selling user to the buying user and refunding to the selling user an amount equal to the specified price for purchase of the reservation.

### BRIEF DESCRIPTION OF THE DRAWINGS

Aspects of certain embodiments of the invention will become apparent upon reading the following detailed description and upon reference to the accompanying drawings in which like references may indicate similar elements:

FIG. 1 depicts a reservation management system with a reservation manager server, one or more user computer systems, and one or more business member computer systems according to some embodiments;

FIG. 2 depicts a block diagram of one embodiment of a computer system suitable for use as a component of the reservation management system, such as a user computer system, business member computer system, or a data processing system to execute the reservation manager;

FIG. 3 depicts a conceptual illustration of software components of a reservation manager according to some embodiments;

FIG. 4 depicts an example of a flow chart for listing a reservation for sale and facilitating transfer of the reservation to a buying user according to some embodiments;

FIG. 5 depicts an example of a flow chart for listing a reservation for sale by a selling user according to some embodiments;

FIG. 6 depicts an example of a flow chart for purchasing a reservation for sale by a buying user according to some embodiments; and

FIG. 7 depicts an example of a flow chart for transferring a reservation from a selling user to a buying user according to some embodiments.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

Generally speaking, systems, methods and media for managing transfers of existing reservations are disclosed, such as by facilitating transfer of an existing reservation from one reservation holder to another. Embodiments of the method may include enrolling one or more business members with the reservation manager and receiving and storing indications of one or more reservations to list for sale, where each of the reservations for sale is associated with an enrolled business member and a selling user holding the reservation. Embodiments may also include receiving from a buying user a request to search reservation listings of reservations listed for sale and generating and transmitting search results based on the received request, where the search results include one or more reservation listings offered for sale that satisfy the received request from the buying user and a price associated with each reservation listing. Embodiments may also include receiving a request from the buying user to purchase a particular reservation from its associated selling user holding the particular reservation. Embodiments may also include transmitting an indication of the purchase of the particular reservation to a business member associated with the particular reservation to facilitate transfer of the particular reservation by the business member from the selling user to the buying user.

The system and methodology of the depicted embodiments allow for effective and efficient management of transfer of existing reservations, such as in response to a desire by a customer to cancel their reservation. By allowing users to list reservations they cannot use for sale on a reservation manager, users have the opportunity to recover some or all of their security deposit if a buyer is found. By providing searchable listings of available reservations, buying users may find a reservation they wish to acquire and may then purchase that reservation. In some cases, the buying user may purchase the reservation at a discount (i.e., for less than the amount of the security deposit). In many cases, the reservation manager may include reservations for services that are no longer available (i.e., they are sold out), providing the opportunity to users to purchase reservations they otherwise could not access. For business members for whom reservations exist, the disclosed system provides an effective and efficient mechanism to facilitate transfers of reservations from one user to another, helping to eliminate unused reservations and also potentially providing a valuable and marketable benefit to its customers.

In general, the routines executed to implement the embodiments of the invention may be part of a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

While specific embodiments will be described below with reference to particular configurations of hardware and/or software, those of skill in the art will realize that embodiments of the present invention may advantageously be implemented with other substantially equivalent hardware, software systems, manual operations, or any combination of any or all of these. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. Moreover, embodiments of the invention may also be implemented via parallel processing using a parallel computing architecture, such as one using multiple discrete systems (e.g., plurality of computers, etc.) or an internal multiprocessing architecture (e.g., a single system with parallel processing capabilities).

Aspects of embodiments of the invention described herein may be stored or distributed on computer-readable medium as well as distributed electronically over the Internet or over other networks, including wireless networks. Data structures and transmission of data (including wireless transmission) particular to aspects of the invention are also encompassed within the scope of the invention. Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Each software program described herein may be operated on any type of data processing system, such as a personal computer, server, etc. A data processing system suitable for storing and/or executing program code may include at least one processor coupled directly or indirectly to memory elements through a system bus. The memory elements may include local memory employed during execution of the program code, bulk storage, and cache memories which provide temporary storage of at least some program code in order to reduce the number of times code must be retrieved from bulk storage during execution. Input/output (I/O) devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices through intervening private or public networks, including wireless networks. Modems, cable modems and Ethernet cards are just a few of the currently available types of network adapters.

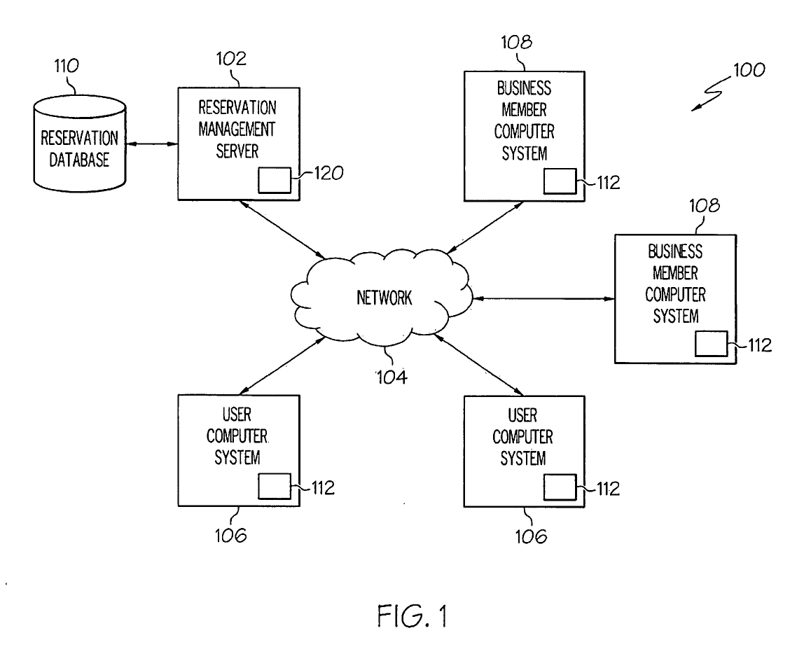

Turning now to the drawings, FIG. 1 depicts a reservation management system 100 with a reservation manager server 102, one or more user computer systems 106, and one or more business member computer systems 108 according to some embodiments. As will be described in more detail subsequently, the disclosed reservation management system 100 may facilitate sale and transfer of existing reservations from a selling user to a buying user by establishing interaction with the business holding the reservation via a business member computer system 108. In the depicted embodiment, the reservation management system 100 includes the reservation management server 102 in communication with a plurality of user computer systems 106 via network 104 and with a plurality of business member computer systems 108 via network 104. While a plurality of client computer systems 102 and business member computer systems 108 are depicted, one of ordinary skill in the art will recognize that the reservation management server 102 may also interact with only single user computer systems 106 and/or business member computer systems 108. For example, the reservation management server 102 and its functionality may be integrated into a single business member computer system 108 to provide reservation sale and purchase capabilities to customers of that business (and may optionally be integrated with its reservation system). In another example, a single user computer system 106 may be used in the event that reservation sale and purchase capability is limited to being performed on a computer hosted in the lobby of the business holding the reservation.

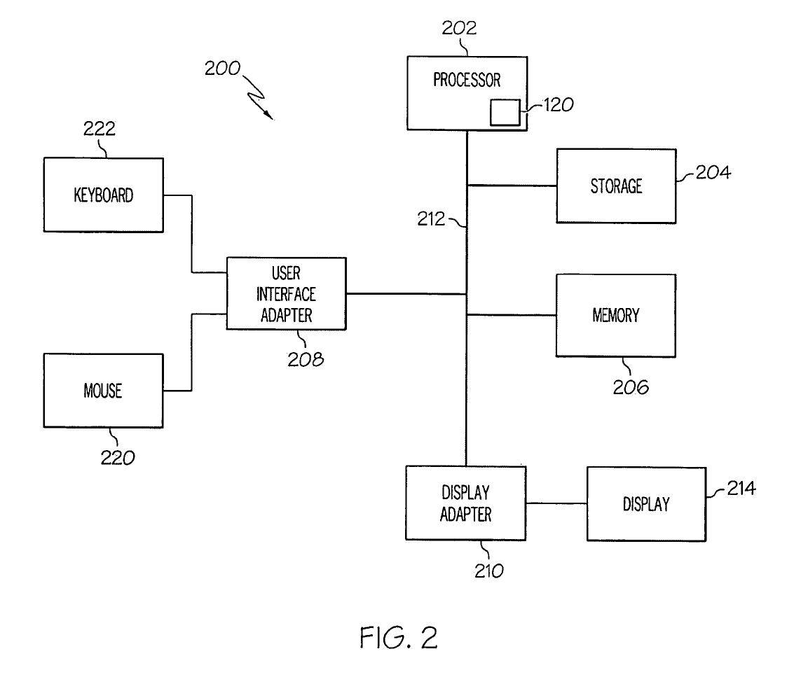

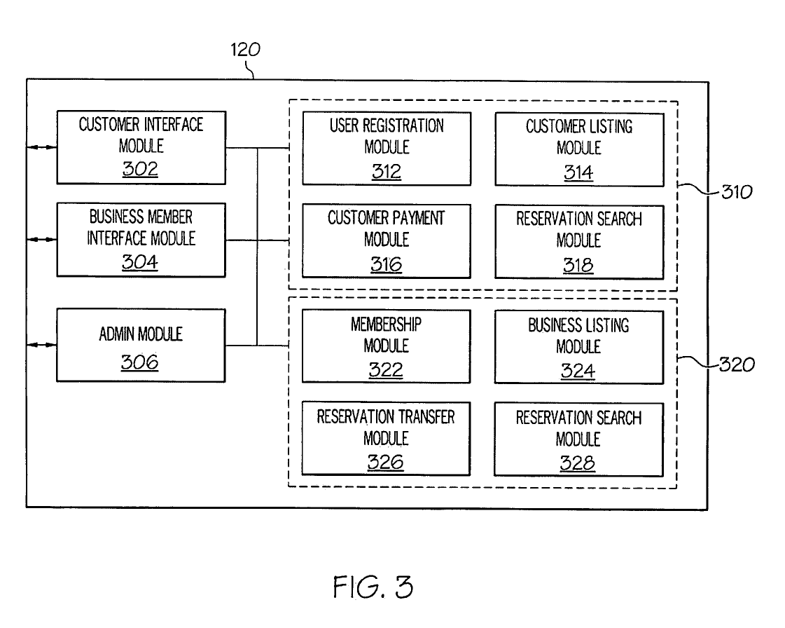

Reservation management server 102 may include one or more servers or other computer systems (such as those described in relation to FIG. 2) adapted to execute a reservation manager 120. The reservation manager 120 may provide a wide range of functionality, including management of transfer of existing reservations by listing, selling, purchasing, and/or transferring ownership of reservations. The reservation management server 102 may be implemented, for example, on one or more application servers such as International Business Machine's (IBM®'s) WebSphere® Application Server (WAS) that may serve as middleware to set up, operate, and integrate e-business applications across multiple computing platforms using Web technologies. As will he described in more detail in relation to FIG. 3, the reservation manager 120 may receive listings of reservations for sale by a selling user, manage those listings, process requests to purchase a reservation by a buying user, and interact with a business via its business member computer system 108 to transfer the reservation from the selling user to the buying user once the reservation is verified. In some embodiments, communications between the reservation management server 102 and the business member computer system 108 (or other components) may be performed via e-mail messages over the Internet (as network 104). While the reservation manager 120 is depicted as part of a reservation management server 102 in a typical embodiment, it may also execute on other components of the reservation management system 100, such as a business member computer system 108, according to other embodiments.

The reservation manager 120 may also have a reservation database 110 to store a variety of files used to manage reservations for sale or otherwise perform its functions. In the depicted embodiment, the reservation database 110 is storage for the reservation management server 102. The reservation database. 110 may be stored on any type or combination of storage devices, including volatile or non-volatile storage such as hard drives, storage area networks, memory, fixed or removable storage, or other storage devices.

Network 104 may be any type of data communications channel or combination of channels, such as the Internet, an intranet, a LAN, a WAN, an Ethernet network, a wireless network, telephone network, a proprietary network, or a broadband cable network. In one example, the Internet may serve as network 104 and the user computer systems 106, the reservation management server 102, and the business member computer systems 108 may communicate via the Internet using known protocols. Those skilled in the art will recognize, however, that the invention described herein may be implemented utilizing any type or combination of data communications channel(s) without departure from the scope and spirit of the invention.

Buying or selling users may utilize a user computer system 106 according to the present embodiments to access the reservation management server 102 (and thus the reservation manager 120) via network 104. User computer system 106 may be a personal computer system or other computer system adapted to execute computer programs, such as a personal computer, workstation, server, notebook or laptop computer, desktop computer, personal digital assistant (PDA), mobile phone, wireless device, or set-top box, such as described in relation to FIG. 2. A user may interact with the reservation manager 120 from their user computer system 106 using a browser 112 or other user interface software. A browser may be a graphical browser application such as Microsoft Corporation's Internet Explorer™, Netscape Communication Corporation's Navigator™, Mozilla Foundation's Firefox, Opera Software ASA's Opera, Apple Corporation's Safari™, etc., that allows users to view Internet or intranet content. Browsers, at their most basic level of operation, permit users to connect to a given network site, download informational content from that site, upload information to that site, and display information to the user. User computer system 106 may also have e-mail functionality via a dedicated e-mail client application (such as Microsoft Corporation's Microsoft Office Outlook®, Mozilla Corporation's Thunderbird, Qualcomm Incorporated's Eudora™, and Apple Computer, Inc.'s AppleMail®, etc.), via a browser-based e-mail client (Microsoft Corporation's Internet Explorer™, Netscape Communication Corporation's Navigator™, Mozilla Foundation's Firefox, Opera Software ASA's Opera, Apple Corporation's Safari™, etc.), or other means. A user may interact with the browser 112 or other applications via user input devices of the user computer system 106 such as a mouse, keyboard, voice input device, etc.

Businesses or other entities that honor reservations may utilize a business member computer system 108 (and browser 112) to interact with the reservation manager 120 according to some embodiments. Business member computer system 108 may be a personal computer system or other computer system adapted to execute computer programs, such as a personal computer, workstation, server, notebook or laptop computer, desktop computer, personal digital assistant (PDA), mobile phone, wireless device, or set-top box, such as described in relation to FIG. 2. Businesses or other entities that take reservations from customer (and keep security deposits) may, according to some embodiments, enroll with the reservation manager 120 so that customers who have made a reservation and placed a security deposit may offer their reservation for sale via the reservation manager 120. Enrollment of business members with the reservation manager 120 may help ensure that transfers will be honored and also facilitate communication of confirmations, financial transfers, and the like. In the event that a second, buying user purchases the reservation, the business may then transfer the registration from the selling user to the buying user.

Various non-limiting examples may serve to further illustrate the disclosed virtual reservation management system 100. In one example, the reservation manager 120 may serve as a centralized resource for buying and selling reservations that are held with business members that are enrolled with the reservation manager 120. If a selling user desired to sell a reservation for a white water rafting trip for which they had placed a non-refundable $1000 security deposit with a river rafting company, they could enter the reservation for sale on the reservation manager 102 and set a price for that sale. If a buying user decided to purchase the reservation at the listed price (say, $750), the reservation manager 120 would then facilitate transfer of the reservation by contacting the river rafting company via their business member computer system 108. The enrolled river rafting company would then transfer the reservation from the selling user to the buying user and refund part of the selling user's security deposit (in this case, $750 of the $1000 total). In the event that a reservation does not sell, in some embodiments the selling user and the associated business member will not be charged for the listing. The disclosed system may thus benefit the selling user as they are able to sell a reservation they can no longer use and at least partially recover their security deposit. The buying user may also benefit by having access to a reservation that might not have been otherwise available (e.g., sold out trip) or may also potentially acquire the reservation at a lower price. The business may benefit also as they ensure that their trip is full (and thus may also increase ancillary revenue from gift shops, etc.) and increase customer satisfaction from the original reservation holder.

In an alternative embodiment, the reservation manager 120 may charge the entire cost of the reserved service to the buying user, not just the sale price of the reservation. If the security deposit was $1000 for a $2000 trip, for example, the buying user might pay $1750 with $750 attributed to the selling user and $1000 (minus costs) attributed to the business member holding the reservation. This embodiment eliminates the need for the buying user and business member to perform a second transaction for the costs above the amount of security deposit. This embodiment may be particularly useful when the reservation will be used close to the time of transfer such that a combined transaction for the full amount will be acceptable to the buying user.

The disclosed reservation management system 100 may potentially generate revenue in a variety of ways. According to some embodiments, business members may be charged for enrollment. Commissions or other fees may also be taken when a reservation transfer actually occurs. Users may also be charged for the ability to list reservations for sale (a certain number of listings may be offered for free as a promotional incentive). Directed advertising or selected services related to purchased reservations may also be utilized, providing additional sources of revenue. While various potential revenue sources are disclosed, options that limit potential buyers (such as charging buyers) may generally not be preferred as such actions may reduce the possibility of successful sales.

FIG. 2 depicts a block diagram of one embodiment of a computer system 200 suitable for use as a component of the reservation management system 100, such as a user computer system 106, business member computer system 108, or a data processing system to execute the reservation manager 120. Other possibilities for the computer system 200 are possible, including a computer having capabilities other than those ascribed herein and possibly beyond those capabilities, and they may, in other embodiments, be any combination of processing devices such as workstations, servers, mainframe computers, notebook or laptop computers, desktop computers, PDAs, mobile phones, wireless devices, set-top boxes, or the like. At least certain of the components of computer system 200 may be mounted on a multi-layer planar or motherboard (which may itself be mounted on the chassis) to provide a means for electrically interconnecting the components of the computer system 200.

In the depicted embodiment, the computer system 200 includes a processor 202, storage 204, memory 206, a user interface adapter 208, and a display adapter 210 connected to a bus 212 or other interconnect. The bus 212 facilitates communication between the processor 202 and other components of the computer system 200, as well as communication between components. Processor 202 may include one or more system central processing units (CPUs) or processors to execute instructions, such as an IBM® PowerPC™ processor, an Intel Pentium® processor, an Advanced Micro Devices Inc. processor or any other suitable processor. The processor 202 may utilize storage 204, which may be non-volatile storage such as one or more hard drives, tape drives, diskette drives, CD-ROM drive, DVD-ROM drive, or the like. The processor 202 may also be connected to memory 206 via bus 212, such as via a memory controller hub (MCH). System memory 206 may include volatile memory such as random access memory (RAM) or double data rate (DDR) synchronous dynamic random access memory (SDRAM). In the disclosed systems, for example, a processor 202 may execute instructions to perform functions of the reservation manager 120, such as by receiving requests to list reservations and requests to purchase reservations, and may temporarily or permanently store information during its calculations or results after calculations in storage 204 or memory 206. All or part of the reservation manager 120, for example, may be stored in memory 206 during execution of its routines. Similarly, processor 202 may execute instructions for the browser 112 when computer system 200 is used for a user computer system 106.

The user interface adapter 208 may connect the processor 202 with user interface devices such as a mouse 220 or keyboard 222. The user interface adapter 208 may also connect with other types of user input devices, such as touch pads, touch sensitive screens, electronic pens, microphones, etc. A user of a user computer system 106 attempting access to purchase a reservation listed for sale, for example, may utilize the keyboard 222 and mouse 220 to interact with their computer system. The bus 212 may also connect the processor 202 to a display 214, such as an LCD display or CRT monitor, via the display adapter 210.

FIG. 3 depicts a conceptual illustration of software components of a reservation manager 120 according to some embodiments. The reservation manager 120 may be implemented on a computer system 200 such as described in relation to FIG. 2, including on one or more servers such as a reservation management server 102. As described previously, the reservation manager 120 may manage purchase, sale, and transfer of reservations as part of a reservation management system 102. The reservation manager 120 may include components to assist it with its functions, including a customer interface module 302, a business member interface module 304, an admin module 306, a customer manager 310, and a business member manager 320. One of ordinary skill in the art will recognize that the functionality of each component of the reservation manager 120 may be combined or divided in any fashion and the description herein is merely intended to be illustrative of some embodiments.

The customer interface module 302 may facilitate communication to and from users via their user computer systems 106 and components of the reservation manager 120, including transmitting and receiving information associated with selling or purchasing a reservation held with an enrolled business member. The business member interface module 304 may facilitate communication to and from businesses via their business member computer systems 108 and components of the reservation manager 120, including transmitting and receiving information associated with enrollment of a business with the reservation manager 120 or transfer of a reservation from a selling user to a buying user.

The admin module 306 may facilitate performance of administrative tasks such as management of user accounts, management of enrolled business member accounts, removal of old or fraudulent reservation listings, or other tasks. In some embodiments, an administrator (i.e., someone with administrator-level access to the reservation manager 120) may configure price adjustment patterns for particular listings, as will be described in more detail subsequently. One of ordinary skill in the art will recognize that the admin module 306 may perform any type of administrative task in support of operation of the reservation manager 120.

The customer manager 310, and its components, may communicate with the customer interface module 302 to assist it in performing its task of managing the sale and purchase of reservations by users. The customer manager 310 may include components such as a user registration module 312, a customer listing module 314, a customer payment module 316, and a reservation search module 318 to assist it in its tasks. The user registration module 312 may register users with the reservation manager 120 according to some embodiments. In some embodiments, listings on the reservation manager 120 may be accessible to any user while some capabilities, such as customized searches, purchasing, or selling may only be available to users who have registered with the reservation manager 120. Registration may typically involve entering personal information (e.g., name, e-mail address, mailing address), payment information (e.g., credit card information), user preferences (e.g., favorite searches, opt-in to updates, etc.), or other information.

The customer listing module 314 may facilitate listings of reservations for sale by selling users (and may optionally be limited to registered users). The customer listing module 314 may provide, for example, an entry form which facilitates selection of an enrolled business member holding a reservation as well as information about the reservation the user wishes to list for sale (e.g., dates, security deposit, price, etc.). The customer listing module 314 may process the request and optionally store a listing based on the request in the reservation database 110.

The customer payment module 316 and reservation search module 318 may be used by buying users to search for and purchase a reservation. The reservation search module 318 may facilitate searches of listings of reservations for sale by buying users. Searches may be customized by selection of limitations or ranges as well as keywords or other search techniques. In some embodiments, registered users may have enhanced search capabilities as well as the ability to save favorite searches, request e-mail updates When new listings appear matching their search requirements, or other enhanced functionalities. The customer payment module 316 may process purchases of reservations (at a specified price) by buying users. Customer payment module 316 may facilitate any type of payment, including credit cards, electronic financial transactions, debit cards, off-line transactions via phone call, or other methodologies.

The business member manager 320, and its components, may communicate with the business member interface module 304 to assist it in performing its task of managing business members for the reservation manager 120. The business member manager 320 may include components such as a membership module 322, a business listing module 324, a reservation transfer module 326, and a reservation search module 328 to assist it in its tasks. The membership module 322 may enroll business members with the reservation manager 122 so that users can list and sell reservations held by those businesses or other organizations. Membership for businesses or other organizations may help in providing for successful facilitation of reservation transfers and may also facilitate additional information being provided with reservation listings. For example, business members may optionally include information about their listings (e.g., promotional material, photographs, descriptions, etc.) to help buying users understand what they are purchasing and to improve the marketability of listed reservations. Reliance on selling users to provide general information may result in inaccuracies and inconsistencies in some cases. Charging businesses for enrollment also provides a potential revenue opportunity for the operator of the reservation manager 120.

The business listing module 324 may facilitate listings of reservations for sale by business members themselves instead of the owner of the reservation (i.e., the selling user). This allows business members to list reservations much like selling users utilize the customer listing module 314, as described above. Similarly, the reservation search module 328 may allow business members to search for all listings associated with them so that they may track progress of reservation sales, potential cancellations, or other aspects. The reservation search module 328 may be similar in operation to the reservation search module 318 according to some embodiments.

The reservation transfer module 326 may transmit an indication of a purchase of a particular reservation to the business member associated with the particular reservation to facilitate transfer of the reservation by the business member from a selling user to a buying user. In some embodiments, the reservation transfer module 326 may generate an e-mail for transmission to an e-mail address associated with the enrolled business member, while in other embodiments, the reservation transfer module 326 may utilize a Web-based interface or other means to communicate such information. The reservation transfer module 326 may also optionally receive confirmation of a completed transfer from the business member. The reservation transfer module 326 may also calculate and handle payment of the purchase price to the business member. In some embodiments, a commission or handling fee may be deducted from the purchase price before transfer.

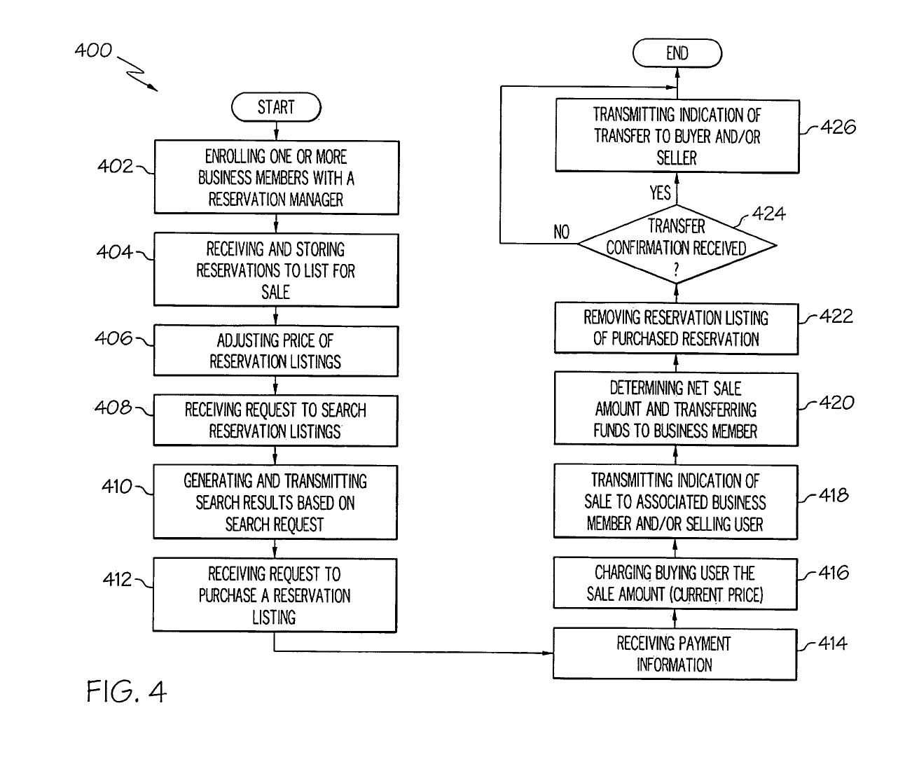

FIG. 4 depicts an example of a flow chart 400 for listing a reservation for sale and facilitating transfer of the reservation to a buying user according to some embodiments. The method of flow chart 400 may be performed, in one embodiment, by the reservation manager 120 and its components. Flow chart 400 begins with optional element 402, enrolling one or more business members with the reservation manager 120. Enrollment of business members with the reservation manager 120 may facilitate transfer of registrations as businesses may provide contact information, contact preferences, etc. to optimize communication of requests to transfer reservations. As described, some embodiments may require for business members to be enrolled before selling users may list reservations with those business members for sale.

The reservation manager 120 may receive reservations and store indications of such reservations for sale from selling users or business members at element 404. Each reservation may be associated with both a selling user holding the reservation and an enrolled business member. The selling user may provide other information, such as the dates and times of the reservation, the asking price for the reservation, the amount of security deposit and the full price of the reservation, or any other information. The associated business member may provide additional information such as a link to its site, marketing materials and descriptions, maps, or other information to help potential buyers understand details of the reservation.

At optional element 406, the asking price of one or more reservation listings may be adjusted. In some embodiments, such an adjustment may be at the request of the seller, such as when the seller requests lowering the price in order to improve the chance of sale. In other embodiments, adjusting the asking price may involve adjusting the asking price downward at a predetermined rate. Such an automatic procedure may have various limits on it, such as limits on the rate of decrease or establishment of various minimums. Empirical evidence of price sensitivity for various reservations may be gathered such that automated price adjustments may provide for optimization of pricing schemes. In yet other embodiments, the asking price may be varied by auction, may have “best offer” capability, or any other means of adjusting prices. Selling users in these embodiments may also request including within the automatic adjustment schemes or opt-out of any automated price adjustments. In some embodiments, sellers may also change the price adjustment methodology (either automatically or upon request) during the listing, such as by switching from a fixed price to an automatically decreasing price once the reservation become closer to expiring.

Once one or more reservations have been listed, the reservation manager 120 may then interact with potential buyers. At element 408, the reservation manager 120 may receive a request to search reservation listings and at element 410, the reservation manager 120 may generate and transmit search results based on the search request. Requests may be received from either users or business members, and in some embodiments enhanced search capabilities may be provided to registered users and/or business members. Users may request, in one example, listings for reservations for a particular weekend, geographic location, and activity or service (such as reservations for the next weekend for skiing and lodging at a bed and breakfast in Vail). At element 412, the reservation manager 120 may receive a request to purchase a particular reservation listing from a buying user and may also receive payment information at element 414 if such information is not on file for that user. In some embodiments, payment information may include a reference to using payment information already on file for the user's account, while in other embodiments it might include information such as credit card or debit card numbers, expiration dates, billing addresses, or other information. The reservation manager 120 may then use the payment information to charge the buying user the sale amount based on the current price of the listing they chose. As described previously, the amount charged to the buying user may be the cost of the reservation itself, the cost of the entire service from the business member, or another amount.

After receiving payment for the purchase of a particular reservation, the reservation manager 120 may at element 418 transfer an indication of the sale to the associated business member to facilitate transfer of the reservation by the business member from the selling user to the buying user. The indication of the sale may include information such as the sale amount, the identify of the buying user, the identity of the selling user, a reservation number, a listing number for the reservation manager 120, dates for the reservation, or any other information. Notification of the sale may also optionally be transmitted to the selling user so that they know that their listing has sold. Notification of the purchase of a reservation to the business member may be performed by e-mail message or any other type of communication technology. At element 420, the reservation manager 120 may also determine the net sale amount and transfer the funds to the business member. The net sale amount is based on the sale amount adjusted for any commissions or fees or any debits or credits for the business member. In some embodiments, determining the net sale amount will involve subtracting a commission or other fee from the sale amount (the price for which the reservation sold). The reservation manager 120 may at element 422 remove the reservation listing of the purchased listing or otherwise mark it so that other users do not attempt to purchase the listing.

If confirmation of the reservation transfer is received from the business member computer system 108 at decision block 424, the reservation manager 120 may optionally transmit an indication of the successful transfer to the buying user and/or the selling user, after which the method may terminate. Confirmation may include an indication of the success of the transfer, confirmation of a refund of the security deposit, or other information. Alternatively, the business member computer system 108 may contact either or both of the buying user and selling user with confirmation of the transfer, refunded security deposit, or other information.

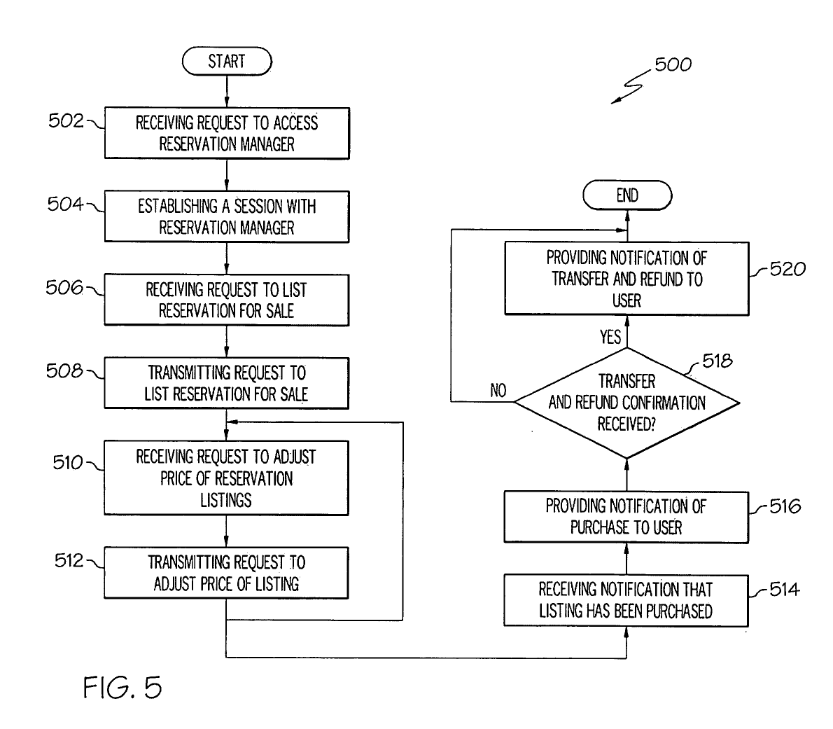

FIG. 5 depicts an example of a flow chart 500 for listing a reservation for sale by a selling user according to some embodiments. The method of flow chart 500 may be performed, in one embodiment, by a user computer system 106 and its components. Flow chart 500 begins with element 502, receiving a request from a user to access the reservation manager 120. The user computer system 106 may then optionally establish a session with the reservation manager 120 at element 504. In some embodiments, establishing a user session will involve the user providing authentication information (such as a password and user id) and the reservation manager 120 authenticating the user and establishing the session. In these embodiments, aspects of the disclosed embodiments, such as the ability to list reservations for sale, may be limited to registered users (who authenticate as part of establishing a session).

Once a session is established, the user computer system 106 may at element 506 receive a request from a user (such as via an input to a graphical user interface) to list a particular reservation for sale. The request may then be transmitted to the reservation manager 120 at element 508. The request may include an identification of the reservation as Well as financial information such as desired sale price, amount of the non-refundable security deposit, or other information. Selection of a reservation may involve entry of all pertinent reservation information by the user (e.g., reservation number, business member, dates, activity, etc.) according to some embodiments, while in other embodiments the user may select from pre-entered lists (e.g., a pull-down menu of enrolled business members) that may also result in some information being pre-filled for the user. For example, selecting a hotel business member from a pull-down list may automatically modify the user interface so that activities, reservation number formats, or other aspects are customized for that particular enrolled business member.

At optional element 510, the user computer system 106 may receive a request to adjust the price of reservation listings for sale and may, at element 512, transmit the request to the reservation manager 120. In some embodiments, the user may have the capability to change the price of their listing for sale as desired, allowing them to lower the price to help increase the changes of sale, for example.

The user computer system 106 may at element 514 receive notification that a listing has been purchased and may, at element 516, provide that information to the selling user. Notification of the sale may be received from the reservation manager 120. If the transfer and refund information has been received at decision block 518 from the business member computer system 108, the user computer system 106 may at element 520 provide notification of the transfer and the refund (and the amount of refund), after which the method may terminate.

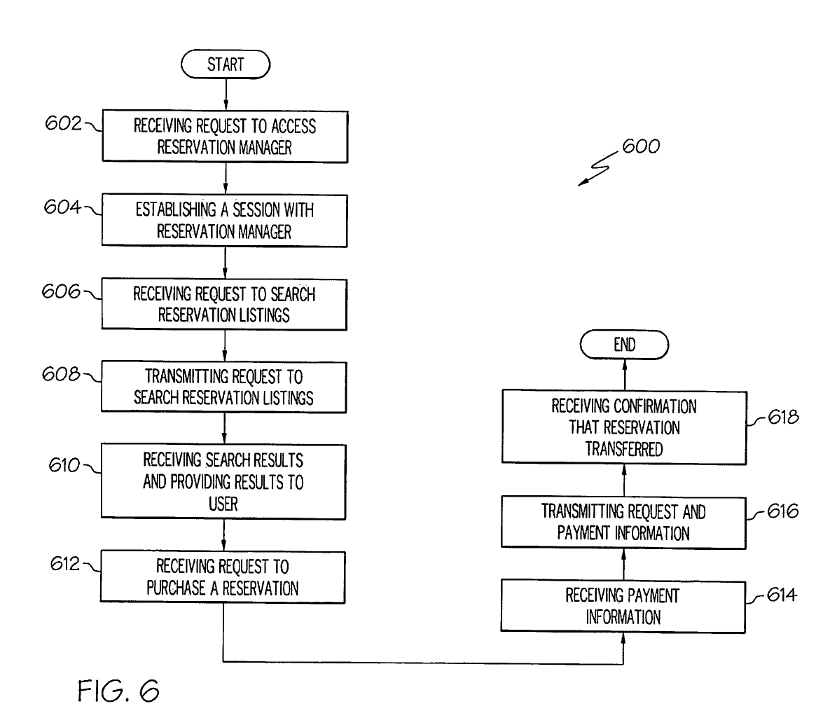

FIG. 6 depicts an example of a flow chart 600 for purchasing a reservation for sale by a buying user according to some embodiments. The method of flow chart 600 may be performed, in one embodiment, by a user computer system 106 and its components. Flow chart 600 begins with element 602, receiving a request from a user to access the reservation manager 120. The user computer system 106 may then establish a session with the reservation manager 120 at element 604. In some embodiments, establishing a user session will involve the user providing authentication information (such as a password and user id) and the reservation manager 120 authenticating the user and establishing the session.

Once a session is established, the user computer system 106 may at element 606 receive a request from a user (such as via an input to a graphical user interface) to search reservation listings based on various parameters. The request may then be transmitted to the reservation manager 120 at element 608. The request may include search limits such as price, activity, geographic region, dates, particular business member, or other information. Selection of search parameters may optionally involve use of a graphical front-end to facilitate entry of search parameters in a format acceptable to the reservation manager 120. At element 610, the user computer system 106 may receive search results from the reservation manager 120 and provide the results to the user.

The buying user may then peruse the search results to see if there are any reservations they wish to purchase, and may also perform additional searches to receive different results. The user computer system may at element 612 receive a request from the buying user to purchase a particular reservation selected from the search results. Payment information may be received by the user computer system 614 if it does not already have such information. The user computer system 106 may then transmit the request and/or payment information to the reservation manager at element 616 to initiate purchase of the reservation. At element 618, confirmation may be received that the reservation has been transferred and provided to the buying user, after which the method may terminate.

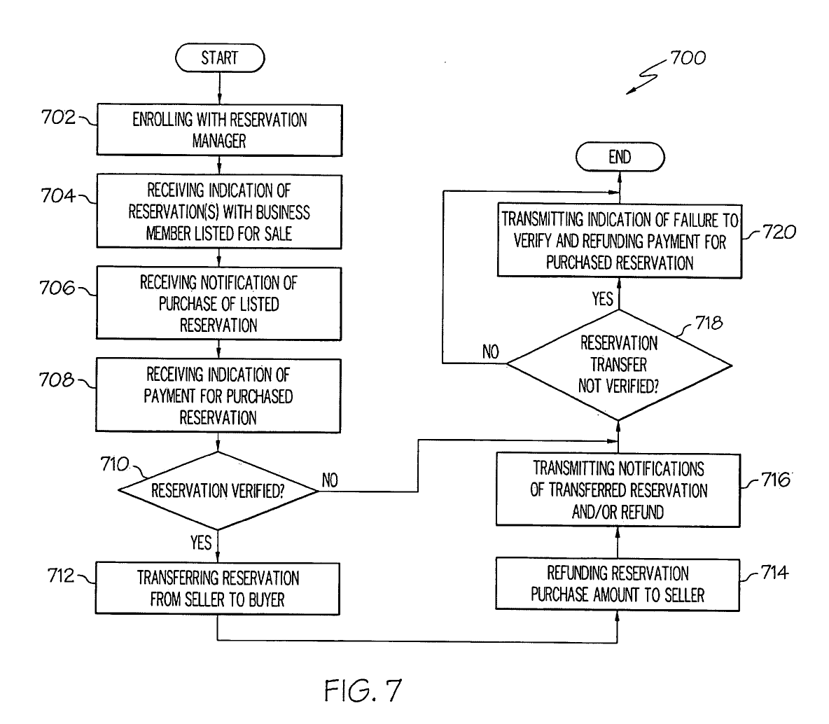

FIG. 7 depicts an example of a flow chart 700 for transferring a reservation from a selling user to a buying user according to some embodiments. The method of flow chart 700 may be performed, in one embodiment, by the business member computer system 108 and its components. Flow chart 700 begins with optional element 702, enrolling the business member associated with the business member computer system 108 with the reservation manager 120. As described previously, enrollment of business members with the reservation manager 120 may include contact information, contact preferences, information about services or facilities, or any other information to help facilitate communication of requests to transfer reservations. The business member computer system 108 may optionally receive indications of any reservations listed for sale that are held with the business member at element 704 so that a business member may have knowledge of what reservations are listed for sale. Business members may also access the reservation manager 120 and search for their reservations or even list reservations for sale according to some embodiments.

The business member computer system 108 may at element 706 receive notification of the purchase of a listed reservation associated with the business member, such as via e-mail message or other communication technology. The business member computer system 108 may also at element 708 receive indication of payment for the purchased reservation (including how much the buying user paid and how much the business member receives) from the reservation manager 120. The business member may then at decision block 710 determine whether the reservation listed is a valid reservation. This task may either be done manually by business member employees (who then enter the result) or may be an automated process of the business member computer system 108. Verification may be particularly useful in combating fraud so that selling user's only receive funds for reservations they sell that they actually hold and have the promised security deposit.

If the reservation is verified, the business member computer system 108 (or an employee) may transfer the reservation from the selling user to the buying user at element 712. The business member or business member computer system 108 may at element 714 refund the reservation purchase amount to the selling user. If the reservation purchase amount was less than the original security deposit, the selling user will not be “made whole” but will reduce their losses by the reservation purchase amount. Notification may be transmitted by the business member computer system 108 at element 716 to the reservation manager 120, selling user, or buying user of the transferred reservation and/or the refunded security deposit.

If the reservation transfer is not verified at decision block 718 (and 710), the business member computer system 108 may at element 720 transmit an indication of the failure to verify to the reservation manager 120 and/or users, after which the method may terminate. The business member may also refund any payment received from the reservation manager 120 if such funds were received prior to verification.

It will be apparent to those skilled in the art having the benefit of this disclosure that the present invention contemplates methods, systems, and media for managing transfer of existing reservations. It is understood that the form of the invention shown and described in the detailed description and the drawings are to be taken merely as examples. It is intended that the following claims be interpreted broadly to embrace all the variations of the example embodiments disclosed, including technologies utilized in the example embodiments as well as other comparable technologies that are known now or later developed.

What is claimed is:

1. A method for managing transfers of existing reservations, the method comprising:
by a reservation manager, enrolling one or more business members with the reservation manager;
by the reservation manager, receiving and storing indications of one or more reservations to list for sale, each of the one or more reservations for sale being associated with an enrolled business member and a selling user holding the reservation;
receiving, by the reservation manager and from a buying user, a request to search reservation listings of reservations listed for sale;
generating and transmitting, by the reservation manager, search results based on the received request, the search results comprising one or more reservation listings offered for sale that satisfy the received request from the buying user and a price associated with each reservation listing;
receiving, by the reservation manager, a request from the buying user to purchase a particular reservation from its associated selling user holding the particular reservation; and
transmitting, by the reservation manager, an indication of the purchase of the particular reservation to a business member associated with the particular reservation to facilitate transfer of the particular reservation by the business member from the selling user to the buying user.

2. The method of claim 1, further comprising:
receiving payment information from the buying user; and
charging the buying user a sale amount associated with the particular reservation purchased.

3. The method of claim 2, further comprising:
determining a net sale amount based on the sale amount associated with the particular reservation purchased; and
transferring funds to the associated business member in an amount equal to the net sale amount.

4. The method of claim 3, wherein determining the net sale amount comprises subtracting a commission from the price associated with the particular reservation purchased.

5. The method of claim 1, further comprising removing the listing for the particular reservation offered for sale.

6. The method of claim 1, further comprising adjusting a price downward for a reservation listed for sale.

7. The method of claim 6, wherein adjusting the price downward for a reservation listed for sale comprises automatically reducing the price at a predetermined rate.

8. The method of claim 6, wherein adjusting the price downward for a reservation listed for sale comprises automatically reducing the price at a predetermined rate until a minimum price is reached.

9. The method of claim 1, further comprising receiving confirmation that a transfer of the particular reservation purchased from the selling user to the buying user was completed.

10. The method of claim 9, further comprising transmitting a confirmation that the transfer was completed to the buying user.

11. The method of claim 9, further comprising transmitting a confirmation that the transfer was completed to the selling user.

12. The method of claim 1, further comprising-transmitting an indication of the purchase of the particular reservation to the selling user.

13. A computer program product comprising a computer-useable medium having a computer readable program, wherein the computer readable program when executed on a computer causes the computer to perform a series of operations for:
enrolling one or more business members with a reservation manager;
receiving and storing indications of one or more reservations to list for sale, each of the one or more reservations for sale being associated with an enrolled business member and a selling user holding the reservation;
receiving from a buying user a request to search reservation listings of reservations listed for sale;
generating and transmitting search results based on the received request, the search results comprising one or more reservation listings offered for sale that satisfy the received request from the buying user and a price associated with each reservation listing;
receiving a request from the buying user to purchase a particular reservation from its associated selling user holding the particular reservation; and
transmitting an indication of the purchase of the particular reservation to a business member associated with the particular reservation to facilitate transfer of the particular reservation by the business member from the selling user to the buying user.

14. The computer program product of claim 13, further comprising:
receiving payment information from the buying user; and
charging the buying user a sale amount associated with the particular reservation purchased.

15. The computer program product of claim 14, further comprising:
determining a net sale amount based on the sale amount associated with the particular reservation purchased; and
transferring funds to the associated business member in an amount equal to the net sale amount.

16. A data processing system having a machine-accessible medium storing a plurality of program modules, the system comprising:
a business member interface module to facilitate communication to and from business members who enroll with a reservation manager;
a customer interface module to facilitate communication to and from users desiring to sell or purchase reservations held with enrolled business members;
a customer manager to manage sale and purchase of reservations by users, the customer manager module comprising:
a customer listing module to facilitate listings of reservations for sale by selling users;
a reservation search module to facilitate searches of listings of reservations for sale by buying users; and
a customer payment module to process purchases of reservations at a specified price by buying users; and
a business member manager to manage business members, the business member manager comprising:
a membership module to enroll business members with the reservation manager; and
a reservation transfer module to transmit an indication of the purchase of a particular reservation to a business member associated with the particular reservation to facilitate transfer of the reservation by the business member from a selling user to a buying user.

17. The system of claim 16, wherein the customer manager further comprises a user register module to register users with the reservation manager.

18. The system of claim 16, wherein the business member manager further comprises a reservation search module to facilitate searches of reservations for sale by business members.

19. The system of claim 16, wherein the reservation transfer module determines a net sale amount based on a sale amount associated with a particular reservation purchased and transfers funds to the associated business member in an amount equal to the net sale amount.

20. The system of claim 16, wherein the customer listing module adjusts the specified price for reservations for sale automatically downward at a predetermined rate.

21. A method for transferring reservations, the method comprising:
enrolling by a business member with a reservation manager;
receiving notification of a purchase by a buying user at a specified price for a particular reservation, the particular reservation being associated with a selling user holding the particular reservation and the enrolled business member;
receiving an indication of payment from the reservation manager for the purchased particular reservation;
verifying the particular reservation held by the selling user;
in response to verifying the particular reservation, transferring the particular reservation from the selling user to the buying user; and
in response to verifying the particular reservation, refunding to the selling user an amount equal to the specified price for purchase of the reservation.

22. The method of claim 21, further comprising receiving an indication when a reservation associated with the enrolled business member is listed for sale.

23. The method of claim 21, further comprising transmitting a notification of transfer of the purchased reservation.

24. The method of claim 21, further comprising transmitting a notification of the refund to the selling user.

25. The method of claim 21, further comprising in response to failing to verify the particular reservation held by the selling user, transmitting an indication of failing to verify the particular reservation.

26. A computer program product comprising a computer-useable medium having a computer readable program, wherein the computer readable program when executed on a computer causes the computer to perform a series of operations for:
enrolling by a business member with a reservation manager;
receiving notification of a request by a buying user to purchase at a specified price a particular reservation associated with a selling user holding the particular reservation and the enrolled business member;
receiving an indication of payment from the reservation manager for the purchased particular reservation;
verifying the particular reservation held by the selling user;
in response to verifying the particular reservation, transferring the particular reservation from the selling user to the buying user; and
in response to verifying the particular reservation, refunding to the selling user an amount equal to the specified price for purchase of the reservation.

27. The computer program product of claim 26, further comprising receiving an indication when a reservation associated with the enrolled business member is listed for sale.

28. The computer program product of claim 26, further comprising transmitting a notification of transfer of the purchased reservation.

29. The computer program product of claim 26, further comprising transmitting a notification of the refund to the selling user.

30. The computer program product of claim 26, further comprising in response to failing to verify the particular reservation held by the selling user, transmitting an indication of failing to verify the particular reservation.
